(19) United States
(12) Patent Application Publication
(10) Pub. No.: US 2023/0330773 A1
(43) Pub. Date: Oct. 19, 2023

(54) LASER PROCESSING DEVICE

(71) Applicant: 4JET microtech GmbH, Alsdorf (DE)

(72) Inventors: Marc HÜSKE, Hannover (DE); Steffen Gerd Josef SCHOLTES, Herzogenrath (DE); Anas MOALEM, Eschweiler (DE); Marc HOLERS, Aachen (DE)

(21) Appl. No.: 18/299,541

(22) Filed: Apr. 12, 2023

(30) Foreign Application Priority Data
Apr. 14, 2022 (DE) 10 2022 109 318.2

(51) Int. Cl. B23K 26/06; B23K 26/03; G02B 5/30

(52) U.S. Cl. CPC B23K 26/0648; B23K 26/032; G02B 5/3083

(57) ABSTRACT

Provided is a laser processing device for processing a workpiece with a processing beam formed by at least a portion of a provided laser radiation, the laser processing device comprising: an analysis device for analyzing a radiation, the radiation being based on the laser radiation; and a control device configured to adjust at least one parameter of the processing beam based on the analysis of the radiation.

This application claims priority to German Patent Application No. 10 2022 109 318.2 filed 14 Apr. 2022, the disclosure of which is hereby incorporated herein by reference.

### TECHNICAL FIELD

The present disclosure relates to the field of laser processing devices.

### BACKGROUND

DE 10 2007 056 254 A1 relates to a device for processing a workpiece by means of a plurality of at least approximately parallel laser beams, the device being equipped with at least one focusing optical system for focusing each laser beam in a common focusing plane.

### SUMMARY

Optimized products, the manufacture of which uses laser processing, mean high requirements for accuracy and quality of laser processing, in particular in the case of small structure sizes and small distances between adjacent laser processing structures.

In view of the situation described above, there may be a need for a technique that allows improved laser processing.

This need may be met by the independent claims. Some advantageous embodiments are indicated in the dependent claims.

In accordance with a first aspect of the subject matter disclosed herein, a laser processing device is provided.

An embodiment of the first aspect provides a laser processing device for processing a workpiece (or component) with a processing beam (which is) formed by at least a portion of a provided laser radiation, the laser processing device comprising: at least one analysis device for analyzing a radiation which (radiation) is based on the laser radiation; a control device configured to adjust at least one parameter of the processing beam based on the analysis of the radiation.

In accordance with a second aspect of the subject matter disclosed herein, a method is provided.

An embodiment of the second aspect provides a method of processing a workpiece with a processing beam formed by at least a portion of a provided laser radiation, the method comprising: analyzing a radiation which is based on the laser radiation; adjusting at least one parameter of the processing beam based on the analysis of the radiation.

In accordance with a third aspect of the subject matter disclosed herein, a laser device is provided.

According to an embodiment of the third aspect, a laser device is provided, the laser device comprising at least two laser processing devices according to the first aspect, wherein for each laser processing device of the at least two laser processing devices, a parameter of its processing beam is adjustable independently of the processing beams of the other laser processing devices of the at least two laser processing devices.

### DESCRIPTION OF EXEMPLARY EMBODIMENTS

Exemplary embodiments of the subject matter disclosed herein are described below, referring, for example, to a method of processing a workpiece with a laser beam and a laser processing device. It should be emphasized that, of course, any combination of features of various aspects, embodiments and examples is possible. In particular, some embodiments are described with reference to a method, while other embodiments are described with reference to a device. Still other embodiments are described with reference to a control device for interacting with further elements of the laser processing device. However, it will be understood by those skilled in the art from the foregoing and subsequent description, claims, and drawings that, unless otherwise indicated, features of various aspects, embodiments, and examples may be combined, and such combinations of features are to be considered disclosed by this application. For example, even a feature relating to a method is combinable with a feature relating to a device, and vice versa.

Also, while certain disadvantages of prior technologies are mentioned herein, the claimed subject matter is not intended to be limited to implementations that address some or all of the mentioned disadvantages of the prior technologies. Further, while certain advantages of the subject matter disclosed herein are mentioned or implied in the present disclosure, the claimed subject matter is not intended to be limited to implementations that address some or all of those advantages.

A laser processing device according to the first aspect is adapted for processing a workpiece with a processing beam, wherein the processing beam is formed by at least a portion of a provided laser radiation. In this sense, the processing beam is the portion of the provided laser radiation emitted by the laser processing device. According to an embodiment, the laser processing device comprises an analysis device configured for analyzing a radiation being based on the (provided) laser radiation (i.e. the radiation is based on the laser radiation). According to another embodiment, the laser processing device comprises a control device configured to adjust at least one parameter of the processing beam based on the analysis of the radiation.

A method according to the second aspect is configured for processing a workpiece with a processing beam, wherein the processing beam is formed by at least a portion of a provided laser radiation. According to an embodiment, the method comprises analyzing a radiation which is based on the laser radiation. Further, according to an embodiment, the method comprises adjusting at least one parameter of the processing beam based on the analysis of the radiation.

According to an embodiment of the third aspect, a laser device comprises at least two laser processing devices according to the first aspect. According to a further embodiment, for each laser processing device of the at least two laser processing devices, a parameter of its processing beam is adjustable independently of the processing beams of the other laser processing devices of the at least two laser processing devices. For example, each of the at least two laser processing devices may have its own controller. According to a further embodiment, a controller of the at least two laser processing devices may be at least partially formed by a common controller.

A processing beam within the meaning of the present disclosure is formed by at least a portion of a provided laser radiation propagating along a ray path from a laser source (from which it is provided) through the laser processing device toward the workpiece and terminating on the workpiece. Along the ray path, in particular within the laser processing device, the laser radiation may be subject to change. For example, the intensity of the laser radiation propagating toward the workpiece may be adjustable (for example, by decoupling a portion of the provided laser radiation), the polarization of the laser radiation may be changed, or a portion of the laser radiation may be decoupled for analyzing the decoupled portion of the laser radiation. In this sense, a decoupled portion of the provided laser radiation may form a radiation according to embodiments of the subject matter disclosed herein, i.e., a radiation being based on the provided laser radiation. However, a radiation according to embodiments of the subject matter disclosed herein is not limited to a decoupled portion of the provided laser radiation, but may generally include any radiation being based on the provided laser radiation. Consequently, the radiation analyzed by the analysis device may also be radiation generated by the processing beam (i.e., by the portion of the provided laser radiation remaining on the ray path).

According to an embodiment, the analysis device is configured to analyze the radiation continuously while the processing beam is being delivered to the workpiece (and thus while the workpiece is being processed by the processing beam). According to another embodiment, the analysis of the radiation is performed at discrete (e.g., predetermined) times.

At least some of the aspects and embodiments of the subject matter disclosed herein are based on the idea that an accuracy and a quality of a laser processing may be improved, in particular in a processing with a plurality of processing beams, by the fact that the focus positions of the individual beams can be individually controlled. At least some of the aspects and embodiments of the subject matter disclosed herein further have the advantage of being readily scalable to a plurality of individual beams while maintaining low complexity of the laser processing device.

According to an embodiment, the workpiece comprises a layer and the processing beam is configured to remove the layer along a track along which the processing beam is guided over the workpiece. For example, the workpiece may be a solar panel.

According to an embodiment, the at least one parameter of the processing beam (which is adjustable by the control device) comprises at least one of the following parameters: a power of the processing beam; a focus position of the processing beam along a beam path of the processing beam; a position of an intersection point of a beam path of the processing beam with the workpiece. As used herein, for ease of distinction, the term “beam path” is assigned to the processing beam and the term “ray path” is assigned to the laser radiation. It is understood, however, that these two terms are not restrictive of the laser radiation and the processing beam, and that the beam path of the processing beam is a part of the ray path of the laser radiation.

In particular, by adjusting (for example, controlling) the focus position of the processing beam in such a way that the focus of the processing beam is on the workpiece (focusing on the workpiece), deviations in structure size and/or structure quality may be avoided in structuring processes. For example, according to an embodiment, deviations of the structure size and/or structure quality are avoided or at least reduced.

According to an embodiment, a structure is a laser processing track, for example, a laser processing track in which a surface layer of a workpiece is removed along the laser processing track. According to an embodiment, the structure size is a track width of the laser processing track. According to another embodiment, the structure quality is a track quality of the laser processing track. According to an embodiment, deviations of the track width and/or track quality with respect to a single track are avoided or at least reduced. According to a further embodiment, deviations of the track width and/or track quality of several tracks among each other are avoided or at least reduced.

According to an embodiment, the processing beam and/or an optical element of the laser processing device which (optical element) serves to condition the processing beam (for example, a focusing lens, also referred to herein as an adjusting lens) is used to generate a laser spot that allows analysis of a focus point of the processing beam. It is understood that, according to an embodiment, further optical elements may be provided. For example, a lens system comprising a plurality of lenses may be provided to focus the processing beam. In this case, the aforementioned optical element serving to condition the processing beam may designate an optical element through which the processing beam exits the laser processing device (i.e., the last optical element in the ray path of the laser radiation). The last optical element (the optical element serving to condition the processing beam or the focusing lens) may also be provided to image a radiation or light from outside the laser processing device into the ray path of the laser radiation inside the laser processing device.

According to an embodiment, the laser processing device comprises an optical element arranged in the ray path of the laser radiation, wherein the radiation comprises a first radiation which is a portion of the laser radiation transmitted by (from) the optical element.

According to an embodiment, analyzing the radiation consequently comprises analyzing the portion of the laser radiation transmitted by the optical element.

The numerical words used with the term “radiation” (e.g., “first” radiation, “second” radiation, etc.) are merely for simplified reference to the radiation concerned. For example, the term “first radiation” is synonymous with “radiation which is a portion of the laser radiation transmitted by the optical element.” In this sense, a reference to a “second radiation” does not require the presence of a “first radiation”. For example, according to an embodiment, the analysis device is configured to analyze at least one of the first radiation, second radiation, third radiation, and fourth radiation described herein. Accordingly, according to an embodiment, the radiation comprises at least one of the first radiation, the second radiation, the third radiation, and the fourth radiation.

According to a further embodiment, the analysis device is configured to determine a power of the processing beam delivered to the workpiece based on the first radiation. For example, the analysis device comprises a correspondingly configured power meter for this purpose. In other words, according to an embodiment, the analysis device comprises a power meter configured to determine a power of the processing beam delivered to the workpiece based on the first radiation, for example by measuring an intensity of the first radiation and determining the power of the processing beam based on a calibration. For example, the power meter comprises a sensor configured to measure a power or an energy of the first radiation reaching the sensor. That is, according to an embodiment, for example, the power of the luminous flux (lighting current) reaching the sensor is measured, or (integrated over a period of time) the energy of the luminous flux reaching the sensor is measured. The sensor may be, for example, a photodetector, which generates, for example, an electric current as a measurement signal. For example, according to an embodiment, electrons generated by the sensor or an electric current generated by the sensor are analyzed.

According to an embodiment, the analysis device is configured to determine a position of the workpiece by means of triangulation by analyzing the radiation. For example, the analysis device comprises an appropriately configured position determination device for this purpose.

Generally herein, according to an embodiment, the position of the workpiece determined by the analysis device is a relative position with respect to the laser processing device. For example, according to an embodiment, the position of the workpiece is a distance of the workpiece from the laser processing device. According to an embodiment, the position of the workpiece is a position relative to a focus position of the processing beam.

According to an embodiment, the laser processing device comprises a so-called laser head from which the processing beam is emitted. According to an embodiment, in an X-Y-Z coordinate system in which the workpiece and the laser head are movable relative to each other in an X direction and a Y direction, the position of the workpiece determined by the analysis device is the Z position of the workpiece, i.e. a position of the workpiece in a Z direction, for example a position of the workpiece in a Z direction with respect to the laser head.

Determining the position of the workpiece by triangulation may be performed in accordance with one or more of the embodiments disclosed herein and/or otherwise.

According to an embodiment, the radiation (which the analysis device analyzes) comprises a second radiation which is a reflected portion of the processing beam from the workpiece. In other words, according to an embodiment, analyzing the radiation comprises analyzing a portion of the processing beam reflected from the workpiece. For example, the analysis device is configured to determine the position of the workpiece by means of triangulation by analyzing a diffuse reflection of the processing beam on the workpiece.

According to an embodiment, the analysis device is configured to determine a position of the workpiece by means of astigmatism by analyzing the radiation. For example, the analysis device has an appropriately configured position determination device for this purpose. For example, according to an embodiment, the beam path of the processing beam is such that a laser spot on the workpiece is a circular laser spot if the processing beam is focused on the workpiece, and that a shape of the laser spot on the workpiece deviates from a circular shape if the workpiece is outside the focus of the processing beam.

According to an embodiment, the radiation (which the analysis device analyzes) comprises a third radiation, which is a portion of the processing beam reflected from the workpiece, which is reflected back into the beam path of the processing beam. According to an embodiment, the focusing lens images the third radiation into the ray path of the laser radiation.

According to an embodiment, the analysis device comprises an astigmatic lens and a position-sensitive detector. According to another embodiment, the position-sensitive detector and the astigmatic lens are configured such that the third radiation passes through the astigmatic lens onto the position-sensitive detector (in other words, the third radiation is incident on the position-sensitive detector through the astigmatic lens) and the position-sensitive detector provides a position signal in response thereto. According to an embodiment, the position signal allows a focusing of the processing beam onto the workpiece. For example, according to an embodiment, the laser processing device comprises a focusing device, wherein the control device is adapted to control the focusing device based on the position signal to thereby focus the processing beam onto the workpiece.

Embodiments of the subject matter disclosed herein provide, as a result, an automatic control of the focus point of the processing beam to focus the processing beam onto the workpiece. According to an embodiment, in case of a plurality of processing beams, an automatic control of the focus point of the processing beam is provided for each of a plurality of processing beams independently of the other processing beams. In this way, deviations in the structure size and/or structure quality of the laser processing tracks generated by the processing beam on the workpiece may be reduced.

According to an embodiment, the astigmatic lens is arranged between the position-sensitive detector and a (first) polarizer. According to an embodiment, the processing beam first passes through the polarizer, and in the opposite direction, coming from the workpiece, the polarizer directs (guides) the third beam onto the position-sensitive detector. According to an embodiment, the polarizer is a polarizing beam splitter.

According to an embodiment, the position-sensitive detector is a 4-quadrant diode. According to another embodiment, the 4-quadrant diode is arranged such that the undistorted laser spot on the workpiece is imaged into the center of the 4-quadrant diode. As a result, the undistorted laser spot (which occurs if the focus is correct) provides the same signal in all four quadrants. If the workpiece is not in the focus of the processing beam, the laser spot is distorted and by suitable calculation of the signals of the four quadrants, an error signal can be determined, which can be used for focus tracking or tuning.

According to an embodiment, the radiation comprises a fourth radiation, which is generated by interaction of the processing beam with the workpiece. Further, according to an embodiment, the analysis device is adapted to analyze the fourth radiation. According to an embodiment, the fourth radiation is a secondary radiation, for example a secondary radiation that is generated by a high intensity of the processing beam and/or an ionization of a material cloud that is generated by the removal of material of the workpiece by the processing beam. According to an embodiment, the analysis device is adapted to determine a position of a starting point for the fourth radiation (for example a position of the material cloud) by analyzing the fourth radiation, for example by means of triangulation.

According to an embodiment, the laser processing device comprises a retardation plate (also referred to herein as a first retardation plate) and a (second) polarizer arranged in the ray path of the laser radiation, wherein the first retardation plate being rotatably supported about an axis of rotation, wherein a rotation of the first retardation plate about the axis of rotation causes a rotation of a direction of polarization of the processing beam and thereby a power of a portion of the laser radiation decoupled (coupled out) by (from) the polarizer is variable. In this way, the portion of the provided laser radiation remaining in the ray path, and thus the power of the processing beam, is variable. According to an embodiment, the first polarizer and the second polarizer are formed by a single, same polarizer. In other words, the second polarizer is the first polarizer. In this case, the numeral word used to distinguish (first, second) may be omitted.

According to an embodiment, the first retardation plate is a lambda-half plate, which retards light polarized parallel to a device-specific axis by half a wavelength (π) with respect to light polarized perpendicular thereto. In this way, a polarization device of linearly polarized light can be rotated by a selectable angle.

According to another embodiment, the laser processing device comprises a power meter, in particular a power meter configured (for example, formed and arranged) to determine a power of the processing beam delivered to the workpiece. According to an embodiment, the power meter is configured to measure a power of a portion of the laser radiation transmitted from an optical element and to determine therefrom (for example, using calibration data) the power of the processing beam. According to an embodiment, the power meter according to one or more of the embodiments disclosed herein is configured, for example, as a photodetector.

According to an embodiment, the determined power of the processing beam is used to control a rotation of the first retardation plate about the axis of rotation. In this way, the power of the processing beam may be controlled to a desired setpoint (for example, an adjustable setpoint).

According to an embodiment, the beam path of the processing beam includes an optical element suitable to rotate a polarization of a portion of the processing beam (i.e., the third radiation) reflected back from the workpiece into the beam path of the processing beam with respect to the processing beam, and thereby increase a portion of the third radiation decoupled (coupled out) by the polarizer with respect to the portion of the processing beam decoupled by the polarizer. According to an embodiment, the optical element is a (second) retardation plate, for example, a lambda-quarter retardation plate, which retards light polarized parallel to a device-specific axis by a quarter wavelength (π/2) with respect to light polarized perpendicular thereto. For example, the lambda-quarter retardation plate may effect a circularly polarized processing beam. A circularly polarized processing beam may provide a better result in laser processing (in particular when processing metals).

According to an embodiment, the second retardation plate is arranged downstream of the polarizer in the propagation direction of the laser radiation. According to a further embodiment, the first retardation plate is arranged upstream of the polarizer in the direction of propagation of the laser radiation.

According to an embodiment, the laser processing device comprises a sensor with which a structure present on a surface of the workpiece can be scanned. For example, the sensor may be an image sensor with which the structure present on the surface of the workpiece can be received or recorded. According to an embodiment, the sensor allows an analysis of the structure present on the workpiece (for example, a determination of the position of the structure present) and thereby allows structuring of the workpiece with the processing beam depending on the structure present on the workpiece. According to an embodiment, the focusing lens images the image of the structure to infinity (i.e., the focusing lens generates parallel beams) before the image is then imaged onto the sensor by a lens assembly. For example, a camera may be provided which has the sensor in the form of a sensor chip and which has the lens assembly in the form of a camera lens.

For example, the present structure is a line-shaped track or a point-shaped track along which a layer of the workpiece has already been removed. For example, a linear track may be a structure in which the layer of the workpiece has been continuously removed along a line (thereby forming a continuous trench in the workpiece). For example, a point-shaped track may comprise a plurality of recesses in the workpiece spaced apart along a line.

According to embodiments of the first aspect, the laser processing device is adapted to provide the functionality of one or more of the embodiments disclosed herein and/or to provide the functionality as required for one or more of the embodiments disclosed herein, in particular the embodiments of the first aspect, the second aspect, and/or the third aspect.

According to embodiments of the second aspect, the method is adapted to provide the functionality of one or more of the embodiments disclosed herein and/or to provide the functionality as required for one or more of the embodiments disclosed herein, in particular the embodiments of the first aspect, the second aspect, and/or the third aspect.

According to embodiments of the third aspect, the laser device is adapted to provide the functionality of one or more of the embodiments disclosed herein and/or to provide the functionality as required for one or more of the embodiments disclosed herein, in particular the embodiments of the first aspect, the second aspect, and/or the third aspect.

Embodiments of the subject matter disclosed herein can be advantageously combined. Particularly noteworthy is the combination of processing the workpiece and analyzing the focusing of the processing beam, in particular analyzing the focusing by triangulation. Furthermore, the combination with power adjustment/power control is also to be emphasized. Thus, an improved laser processing device may be achieved, for example in terms of efficient design, reduced dimensions, etc. In particular, at least one element (e.g., an element of the laser processing device, e.g., a polarizer) may be provided for realizing two or more embodiments (e.g., realizing power adjustment/power control and decoupling of radiation to a detector).

Further advantages and features of the present disclosure will be apparent from the following exemplary description of currently preferred embodiments, to which, however, the present disclosure is not limited. The individual figures of the drawings of this document are to be considered merely schematic and not to scale.

### BRIEF DESCRIPTION OF THE DRAWINGS

FIG. 1 schematically shows a laser processing device in accordance with embodiments of the subject matter disclosed herein.

FIG. 2 to FIG. 4 show the detector of FIG. 1 when viewed from line II-II.

FIG. 5 shows another position determining device in accordance with embodiments of the subject matter disclosed herein.

FIG. 6 shows a laser processing device in accordance with embodiments of the subject matter disclosed herein.

FIG. 7 shows a side view of a laser device in accordance with embodiments of the subject matter disclosed herein.

### DETAILED DESCRIPTION

It is noted that in different figures similar or identical elements or components are provided with the same reference numerals, or with reference numerals differing only in the first digit or an appended letter. Such features or components that are identical or at least functionally identical to the corresponding features or components in another figure are described in detail only on their first occurrence in the following text, and the description is not repeated on subsequent occurrences of those features and components (or the corresponding reference numerals).

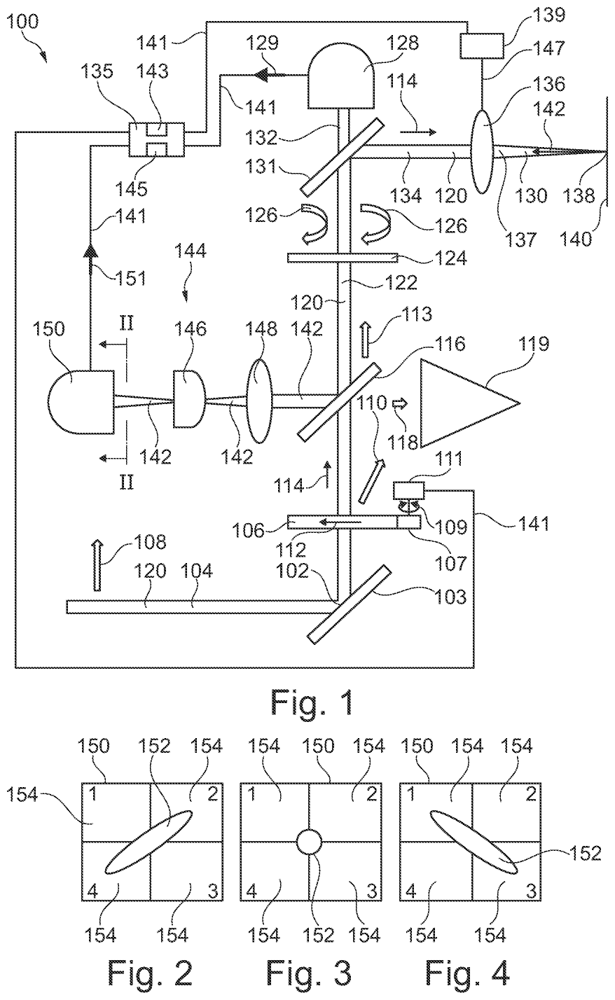

FIG. 1 schematically shows a laser processing device 100 in accordance with embodiments of the subject matter disclosed herein. According to an embodiment, the laser processing device 100 comprises a beam inlet 102 via which a provided laser radiation 104 may be coupled into the laser processing device 100. According to an embodiment, the beam inlet 102 is formed by a mirror 103, for example as shown in FIG. 1.

According to an embodiment, the laser processing device 100 comprises a first retardation plate 106 in the form of a lambda-half plate that changes a polarization of the laser radiation 104 from a first polarization 108 to a second polarization 110. According to an embodiment, the second polarization 110 (or the change from the first polarization 108 to the second polarization 110) is adjustable by rotating the first retardation plate 106 in a plane transverse to the laser radiation 104, for example in a plane perpendicular to the laser radiation 104, for example as shown at 112 in FIG. 1. According to another embodiment, the laser processing device 100 comprises an actuator 111 (for example, a motor) for rotating the first retardation plate 106. According to an embodiment, the rotating of the first retardation plate 106 may be performed by a gear (not shown in FIG. 1) on the outer periphery of the retardation plate 106, which is drivable about an axis of rotation (for example, an axis of rotation parallel to an optical axis of the laser radiation 104 at the location of the first retardation plate 106) via a drive wheel 107 engaged with the outer gear. According to another embodiment, the actuator 111 is configured to drive the drive wheel 107, exemplified at 109. According to an embodiment, the first retardation plate 106 (or the drive wheel 107) is drivable bidirectionally (i.e., in a forward direction and a reverse direction), for example by the actuator 111.

According to a further embodiment, a polarizer 116 is arranged downstream of the first retardation plate 106 in the beam direction 114 of the laser radiation 104, which polarizer 116 decouples a portion 118 of the laser radiation 104 from a ray path 120 of the laser radiation 104, thereby reducing the power of the laser radiation 122 remaining in the ray path 120. The decoupled portion 118 may be fed to an absorber 119, for example, as shown in FIG. 1. After (downstream of) the polarizer, the remaining laser radiation has a third polarization 113, for example as shown in FIG. 1.

According to an embodiment, the one analysis device of the laser processing device 100 comprises a power meter 128 configured to determine a power of a processing beam 130 emitted from the laser processing device 100. For example, according to an embodiment, the laser processing device 100 comprises an optical element 131 that decouples a further portion 132 of the laser radiation 104 from the ray path 120 and supplies it to the power meter 128, for example as shown in FIG. 1. According to an embodiment, the optical element 131 is formed by a mirror, for example as shown in FIG. 1. After calibration of the power meter 128, a power of a portion 134 of the laser radiation 104 forwarded by the optical element 131, which forms the processing beam 130, may be determined from the decoupled further portion 132 of the laser radiation 104. According to an embodiment, corresponding calibration data is stored in a control device 135 of the laser processing device 100. According to an embodiment, a focusing lens 136 is arranged downstream of the optical element 131 in the beam direction 114, which focusing lens 136 focuses the forwarded portion 134 of the laser radiation 104 to generate the processing beam 130 in this way. Accordingly, the processing beam 130 is formed by a part of the provided laser radiation 104.

According to an embodiment, the focusing lens 136 represents the last optical element of the laser processing device 100 in the beam direction 114. In other words, according to an embodiment, the processing beam 130 is emitted from the last optical element of the laser processing device 100, such as the focusing lens 136. Thus, a beam path 137 of the processing beam 130 forms a part of the ray path 120 of the laser radiation 104. The processing beam 130 is used for processing a workpiece 140.

The focusing lens 136 focuses the processing beam 130 to a focus 138, which is also referred to as the focal point. For high-quality laser processing, it is advantageous if the focus 138 is located on the workpiece 140. According to an embodiment, a position of the focus along the processing beam 130 or along the beam path 137 is adjustable, for example by means of the focusing lens 136. According to an embodiment, a position of the focusing lens 136 is adjustable by means of an actuator 139 for thereby adjusting the position of the focus 138 along the beam path 137. The actuator 139 may be, for example, a motor which is drivingly coupled to the focusing lens 136, for example as indicated in FIG. 1 at 147. In other words, according to an embodiment, the focusing lens 136 is a motor-driven lens. According to an embodiment, the workpiece is a solar module and the processing beam is used for removing a layer (for example, a conductive layer) of the solar module along a track along which the focus is guided over the workpiece 140.

According to an embodiment, the laser processing device 100 comprises an analysis device. According to another embodiment, the analysis device comprises a position determination device 144 for determining a relative position of the workpiece 140 with respect to the laser processing device 100. According to an embodiment, determining the relative position of the workpiece 140 with respect to the laser processing device 100 comprises (or consists of) determining whether the focus 138 is on the workpiece 140. To this end, according to an embodiment, the position determination device 144 is configured to determine the relative position of the workpiece 140 with respect to the focus 138 by analyzing a radiation (also referred to herein as third radiation) which radiation is based on the laser radiation 104. According to an embodiment, a determination of a relative position of the workpiece 140 with respect to the focus 138 is equivalent to a determination of a relative position of the focus 138 with respect to the workpiece 140, and vice versa. According to an embodiment, the (third) radiation is a (back-reflected) portion 142 of the processing beam 130 reflected back from the workpiece 140 into the beam path 137 of the processing beam 130 (and thus a portion 142 of the processing beam 130 reflected back from the workpiece 140 into the ray path 120).

According to an embodiment, the position determination device 144 is configured to determine the position of the workpiece 140 using astigmatism by analyzing the third radiation 142. For example, according to an embodiment, the position determination device 144 may include an astigmatic lens 146. According to an embodiment, the astigmatic lens 146 is a cylindrical lens. Further, according to an embodiment, the position determining device 144 comprises another lens 148 that focuses the back-reflected portion 142 of the processing beam 130 onto a principal plane (main plane) of the astigmatic lens 146, provided that the focus 138 is on the workpiece 140. A detector 150 is arranged opposite the astigmatic lens 146 (on a side of the astigmatic lens 146 facing away from the further lens 148). According to an embodiment, the detector 150 detects the back-reflected portion 142 exiting the astigmatic lens 146 (i.e., the third radiation) and provides a position signal 151 in response thereto. According to an embodiment, the detector 150 is a 4-quadrant diode.

Compared to a correctly focused processing beam 130, in which the focus 138 is located on the workpiece 140, when the focus is not correctly focused (for example, if the focus is located at a distance in front of the workpiece 140), the area irradiated by the processing beam 130 on the workpiece 140 is larger. This larger irradiated area of the workpiece 140 results in a change in the back-reflected portion 142, for example, a spatially altered intensity distribution of the portion 142 reflected back into the ray path 120. According to an embodiment, the position determination device 144 is configured such that when the processing beam 130 is not correctly focused, the back-reflected portion 142 is subject to astigmatic distortion by the astigmatic lens 146. In other words, the position determination device 144 is configured such that an incorrectly focused processing beam 130 (i.e., the focus 138 is not on the workpiece 140) results in a different intensity distribution of the back-reflected portion 142 on the detector 150 than a correctly focused processing beam 130. For example, according to an embodiment, when the processing beam 130 is not correctly focused, the further lens 148 does not focus the back-reflected portion 142 into the principal plane (or one of the principal planes) of the astigmatic lens 146, resulting in the astigmatic distortion.

The laser processing device 100 is typically designed such that the portion 118 decoupled by the polarizer 116 is as small as possible compared to the remaining laser radiation 122. In this way, the laser processing device may be operated with high efficiency since the majority of the provided laser radiation 104 is used to process the workpiece.

According to an embodiment, the analysis device comprises at least one optical element that can increase a yield of the back-reflected portion 142 on the detector 150. For example, according to an embodiment, a second retardation plate 124 is arranged in the ray path 120. According to an embodiment, the second retardation plate is arranged downstream of the polarizer 116 in the beam direction 114, for example as shown in FIG. 1. According to an embodiment, the second retardation plate 124 is a lambda-quarter plate that changes the linear polarization of the remaining laser radiation 122 to a circular polarization, as indicated at 126 in FIG. 1. Consequently, the back-reflected portion 142 of the processing beam 130 also passes through the second retardation plate 124 before the back-reflected portion 142 is incident on the polarizer 116. By passing through the second retardation plate 124 twice (once in the beam direction 114 as laser radiation 104 and once against the beam direction 114 as the back-reflected portion 142), the polarization of the back-reflected portion 142 is rotated by 90 degrees with respect to the remaining laser radiation 122 (which propagates in the direction of the workpiece 140) before it is incident on the polarizer 116. In this manner, a high proportion of the back-reflected portion 142 is decoupled by the polarizer 116 from the ray path 120 and directed onto the further lens 148. Consequently, the second retardation plate 124 increases the yield of the back-reflected portion 142 on the detector 150. In this manner, a reliable operation of the position determination device 144 may be achieved.

According to an embodiment, signal-emitting or signal-receiving components of the laser processing device 100 are signal-transmission coupled to the control device 135, indicated at 141 in FIG. 1.

For example, according to an embodiment, the power meter 128 is signal-transmission coupled to the control device 135 for transmitting a measurement signal 129 to the control device 135. According to an embodiment, the measurement signal 129 indicates a measured power of the first radiation 132. In this case, the control device 135 may be configured to determine a power of the processing beam 130 based on calibration data from the measurement signal 129. According to another embodiment, determining a power of the processing beam 130 may be performed by the power meter 128. In this case, the measurement signal 129 may indicate the power of the processing beam 130. According to an embodiment, the control device 135 is configured to adjust the first retardation plate 106 based on the determined power of the processing beam 130 (and, according to a further embodiment, based on a power setpoint), for example, by means of the actuator 111 (which is configured to rotate the second retardation plate). For example, according to an embodiment, the control device 135 is signal transmission coupled to the actuator 111 for this purpose. In this way, an efficient and compact power control of the processing beam 130 may be realized.

According to an embodiment, the position determination device 144 is signal-transmission coupled to the control device 135, for example, for transmitting the position signal 151 to the control device 135. According to another embodiment, the control device 135 is signal-transmission coupled to the actuator 139, for adjusting a position of the focus 138 along the beam path 137. In this way, an efficient and compact focus control may be realizable.

According to an embodiment, the control device 135 comprises a processor device 143 and a memory device 145 for storing at least one computer program configured to, when executed on the processor device 143, control a method according to one or more embodiments of the subject matter disclosed herein and thereby provide functionality of the laser processing device 100 as described in one or more embodiments of the subject matter disclosed herein.

FIG. 2 to FIG. 4 show the detector 150 of FIG. 1 when viewed from line II-II.

According to an embodiment, the back-reflected portion 142 of the processing beam 130 forms a radiation spot 152 on the detector 150, for example as shown in FIG. 2. The radiation spot 152 thus corresponds to the intensity distribution of the back-reflected portion 142 of the processing beam 130 on the detector 150. According to an embodiment, the detector 150 comprises a plurality of detector segments 154, for example as shown in FIG. 2. According to an embodiment, each detector segment 154 generates a detector signal indicative of the intensity of the back-reflected portion 142 of the processing beam 130 impinging on the detector segment 154. For example, according to an embodiment, the detector 150 has four detector segments 154, and is formed, for example, by a 4-quadrant diode, for example as shown in FIG. 2. In FIG. 2, the four detector segments 154 are consecutively numbered 1 to 4 in a clockwise direction.

According to an embodiment, the position determination device 144 is configured such that when the focus 138 is positioned in front of the workpiece 140, the radiation spot 152 extends substantially into the second quadrant 2 and the fourth quadrant 4 of the detector 150, for example as shown in FIG. 2. This can be achieved, for example, by suitably rotating the astigmatic lens 146 about the optical axis of the back-reflected portion 142.

According to another embodiment, the position determination device 144 is configured such that the radiation spot 152 extends substantially equally into all four quadrants 1, 2, 3, 4 when the processing beam 130 is correctly focused, for example as shown in FIG. 3.

According to another embodiment, the position determination device 144 is configured such that when the focus 138 is positioned in the workpiece or behind the workpiece, the radiation spot 152 extends substantially into the first quadrant 1 and the third quadrant 3 of the detector 150, for example as shown in FIG. 4.

According to an embodiment, the position signal 151 may be calculated as follows.

According to an embodiment, each of the four detector segments 1, 2, 3, 4 generates an output signal Pi (wherein i identifies the respective detector segment, i=1, 2, 3, 4). According to an embodiment, the output signal Pi is dependent on a detected intensity of the back-reflected portion 142, i.e., the output signal Pi is dependent on the portion of the back-reflected portion 142 that is incident on the detector segment i.

According to an embodiment, the position signal P is then given by

P=(P1+P3)−(P2+P4)

Consequently, P=0 if the focus 138 is on the workpiece (in the embodiment according to which, if the focus is correct, P1=P2=P3=P4).

A normalized position signal Pn is then given by

Pn=P/(P1+P2+P3+P4)

The sum of the output signals Pi of the detector segments 154 (i=1, 2, 3, 4), after calibration, further allows determination of the power of the processing beam 130.

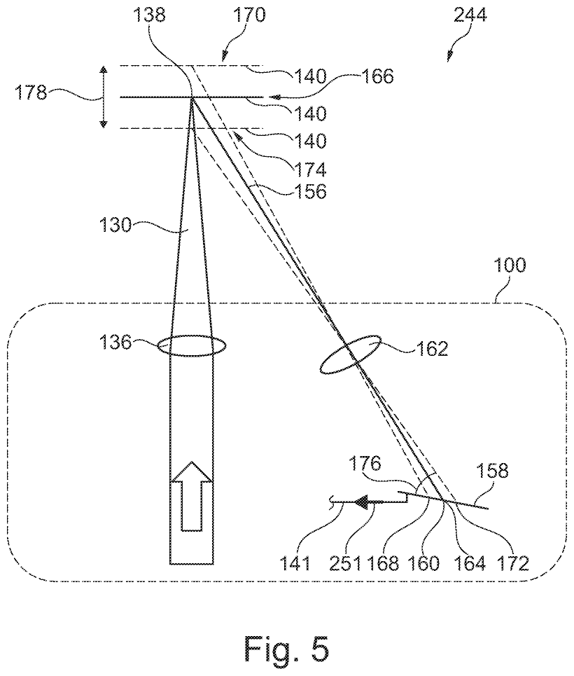

FIG. 5 shows another position determining device 244 in accordance with embodiments of the subject matter disclosed herein.

According to an embodiment, the position determination device 244 is configured to determine a position of the workpiece 140 using triangulation by analyzing a radiation (also referred to herein as a second radiation) being based on the processing beam 130. For example, according to an embodiment, the second radiation is a reflected portion 156 of the processing beam 130 from the workpiece (wherein the reflected portion 156 is not reflected back into the ray path 120). According to an embodiment, the reflected portion 156 is detected by a detector 158 that is spaced apart from the radiation path 137 of the processing beam, for example as shown in FIG. 5.

According to an embodiment, the detector 158 is a position-sensitive detector providing a position signal 251, wherein the position signal 251 is dependent on an incident position 160 of the reflected radiation 156.

According to an embodiment, the position determination device 244 includes a measuring lens 162 that images the reflected portion 156 of the processing beam onto the detector 158, for example as shown in FIG. 5.

According to an embodiment, the incident position 160 is located at a first location 164 when the focus 138 is on the workpiece 140 (first position 166 of the workpiece). According to another embodiment, the incident position 160 is at a second location 168 when the focus 138 is in front of the workpiece 140 (second position 170 of the workpiece 140). According to yet another embodiment, the incident position 160 is located at a third location 172 when the focus 138 is in or behind the workpiece 140 (third position 174 of the workpiece 140). It is understood that the workpiece 140 in FIG. 5 is always located at only one of the three positions 166, 170, 174 shown. For this reason, the workpiece is drawn with a solid line in the first position 166, whereas it is shown with dashed lines in the second position 170 and in the third position 174. The same applies to the representation of the reflected portion 156 of the processing beam. When viewed in FIG. 5, the position of the focus 138 is assumed to be unchanged for all three positions 166, 170, 174 shown.

According to an embodiment, the detector 158 is configured such that the reflected portion 156 of the processing beam 130 is incident on the detector 158 at an angle of incidence 176, wherein the angle of incidence is less than 90 degrees, for example as shown in FIG. 5. According to an embodiment, the angle of incidence is in a range between 20 degrees and 60 degrees. In this way, even if the position of the workpiece 140 changes slightly in a direction 178 (for example, a Z direction) parallel to the processing beam 130, a sufficiently large change in the incident position 160 is achieved. Consequently, in this way, a high resolution of the position determination of the workpiece 140 in a direction parallel to the processing beam 130 is made possible.

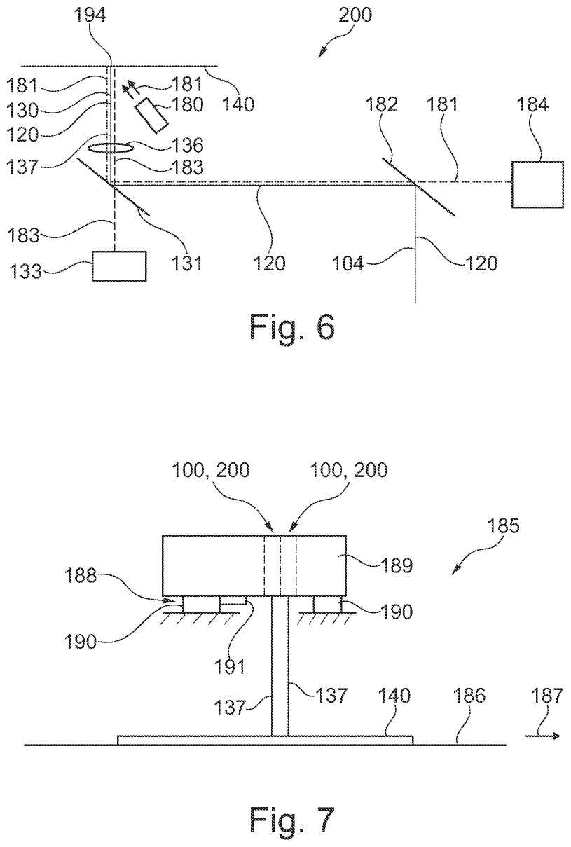

FIG. 6 shows a laser processing device 200 in accordance with embodiments of the subject matter disclosed herein.

According to an embodiment, the processing beam 130 or its beam path 137 intersects the workpiece 140 at an intersection point 194. According to an embodiment, the laser processing device 200 comprises a light source 180 configured to illuminate the workpiece 140 (in particular at the intersection point 194 and adjacent to the intersection point 194) with a light 181, wherein the light 181 has a wavelength that is different from the wavelength of the processing beam 130. According to an embodiment, an optical element 182 of the laser processing device 200 is at least partially transparent to the light 181, for decoupling the light 181 from the ray path 120 of the laser radiation 104, for example as shown in FIG. 6. According to an embodiment, the laser processing device 200 further comprises an image sensor 184 for sensing the light 181 decoupled from the ray path 120. According to an embodiment, the image sensor 184 generates image data corresponding to the decoupled light 181. In this way, the image sensor 184 can be used to image the workpiece 140 in a vicinity of the intersection point 194, corresponding to the portion of the workpiece that is imaged on the image sensor by the decoupled light 181. Consequently, the image sensor 184 can be used to optically scan the workpiece during laser processing. For example, the laser processing device 200 may be configured to use the image sensor 184 to scan an existing marking on the workpiece 140 and, based on the scanned existing marking on the workpiece 140, to position the processing beam 130 and the workpiece 140 relative to each other, in particular in a plane transverse to the processing beam 130. According to an embodiment, such positioning of the workpiece 140 and the processing beam 130 based on an existing marking on the workpiece 140 is performed by at least one transport device (not shown in FIG. 6).

According to an embodiment, the radiation analyzed by the analysis device comprises a fourth radiation 183, which is generated by interaction of the processing beam 130 with the workpiece. According to an embodiment, the analysis device comprises a detector 133 configured to analyze the fourth radiation 183. According to an embodiment, an optical element defining the ray path 120 of the laser radiation 104 (for example, the optical element 131, as shown in FIG. 6) is configured to decouple at least a portion of the fourth radiation 183 from the ray path 120. In this way, the fourth radiation 183 can be made available to the detector even when the detector is located outside the ray path 120, for example, as shown in FIG. 6.

As described above, according to an embodiment, an analysis device within the meaning of the subject matter disclosed herein is configured to analyze at least one of
the first radiation 132;
the second radiation 156;
the third radiation 142;
the fourth radiation 183.

Accordingly, according to an embodiment, an analysis device within the meaning of the subject matter disclosed herein comprises at least one of
the power meter 128,
the position determination device 144,
the position determination device 244,
the detector 133.

FIG. 7 shows a side view of a laser device 185 in accordance with embodiments of the subject matter disclosed herein.

According to an embodiment, the laser device 185 comprises at least two laser processing devices 100, 200 as described with reference to FIG. 1 to FIG. 6. According to an embodiment, the at least two laser processing devices 100, 200 are integrated into a single laser head 189. Embodiments of the subject matter disclosed herein enable a plurality of laser processing devices 100, 200 to be integrated into a single laser head 189 and, in so doing, to adjust for each laser processing device a parameter of its processing beam independently of the processing beams of the other laser processing device of the laser device 185. In particular, this is enabled by using a radiation being based on the laser radiation from which the processing beam is formed.

According to an embodiment, the laser device 185 comprises a first transport device, for example a conveyor belt 186, by means of which the workpiece 140 is movable in a first transport direction 187. According to an embodiment, the laser device 185 comprises a second transport device 188, by means of which the laser head 189 is movable transversely to the first transport direction 187 (for example perpendicular to the first transport direction 187). According to an embodiment, the second transport device 188 comprises guide rails 190 and an actuator 191 for moving the laser head 189 relative to the guide rails 190. According to an embodiment, the actuator 191 is formed by a linear motor.

According to an embodiment, the control devices of the at least two laser processing devices are formed by a single common control device.

It should be noted that an optical element as described herein is not limited to the decided entities as described in some embodiments. Rather, the subject matter disclosed herein may be implemented in numerous ways while still providing the disclosed specific functionality.

It is noted that each entity disclosed herein (e.g., an element, a component, a unit, or a device) is not limited to a decided entity as described in some embodiments. Rather, the subject matter described herein may be provided in different ways with different granularity at the device level or at the process step level while still providing the specified functionality. Further, it should be noted that according to embodiments, a separate entity may be provided for each of the functions disclosed herein. According to other embodiments, an entity may be configured to provide two or more functions as described herein. According to still other embodiments, two or more entities may be configured to collectively provide one function as described herein. For example, the analysis device may comprise two or more analysis units, wherein each analysis unit provides a portion of a functionality of the analysis device.

According to an embodiment, the control device includes a processor device comprising at least one processor for executing at least one program element, which may correspond to a corresponding software module.

A definition of an optical arrangement or an optical geometry with reference to a laser radiation may of course also be defined analogously with reference to a radiation path of the laser radiation, and vice versa. In this respect, any reference herein to a laser radiation analogously discloses a reference to a radiation path of the laser radiation, and vice versa.

It is noted that the embodiments described herein represent only a limited selection of possible embodiments of the present disclosure. Thus, it is possible to combine the features of different embodiments in a suitable manner, so that for those skilled in the art, a variety of combinations of different embodiments are to be considered disclosed with the embodiments explicitly disclosed herein. For example, the image sensor 184, which is shown in FIG. 6, may also be included in the laser processing device 100 shown in FIG. 1. Further, the polarizer 116 may also be included in the laser processing device 200 of FIG. 6, for example between the optical element 182 and the optical element 131.

It should also be mentioned that terms such as “a” or “an” do not exclude a plurality. Terms such as “containing” or “comprising” do not exclude further features or process steps. Consequently, according to an embodiment, the term “containing” or “comprising” stands for “comprising, inter alia”. According to a further embodiment, the term “containing” or “comprising” stands for “consisting of”. According to an embodiment, the term “adapted to” includes, but is not limited to, the meaning “configured to”.

It should also be noted that reference signs in the claims should not be construed as limiting the scope of the claims. It should also be noted that reference signs in the description and the description's reference to the drawings should not be construed as limiting the scope of the description. Rather, the drawings illustrate only an exemplary implementation of a particular combination of several embodiments of the subject matter disclosed herein, any other combination of embodiments being equally possible and to be considered disclosed by this application.

In summary, it remains to be stated:

Provided is a laser processing device for processing a workpiece with a processing beam formed by at least a portion of a provided laser radiation, the laser processing device comprising: an analysis device for analyzing a radiation, the radiation being based on the laser radiation; and a control device configured to adjust at least one parameter of the processing beam based on the analysis of the radiation.

1. A laser processing device for processing a workpiece with a processing beam formed by at least a portion of a provided laser radiation, the laser processing device comprising:
an analysis device for analyzing a radiation which is based on the laser radiation;
a control device configured to adjust at least one parameter of the processing beam based on the analysis of the radiation.

2. The laser processing device according to claim 1, wherein the at least one parameter of the processing beam comprises at least one of the following parameters:
a power of the processing beam;
a focus position of the processing beam along a beam path of the processing beam;
a position of an intersection point of a beam path of the processing beam with the workpiece.

3. The laser processing device according to claim 1,
further comprising an optical element arranged in a ray path of the laser radiation;
wherein the radiation comprises a first radiation which is a portion of the laser radiation transmitted by the optical element.

4. The laser processing device according to claim 3,
wherein the analysis device further comprises a power meter configured to determine a power of the processing beam delivered to the workpiece based on the first radiation.

5. The laser processing device according to claim 4,
wherein the power meter is configured to determine the power of the processing beam delivered to the workpiece based on the first radiation by measuring an intensity of the first radiation and determining the power of the processing beam based on a calibration.

6. The laser processing device according to claim 1,
wherein the analysis device is configured to determine a position of the workpiece by analyzing the radiation using triangulation.

7. The laser processing device according to claim 6,
wherein the radiation comprises a second radiation which is a reflected portion of the processing beam from the workpiece.

8. The laser processing device according to claim 1,
wherein the analysis device is configured to determine a position of the workpiece by analyzing the radiation using astigmatism.

9. The laser processing device according to claim 8, wherein
the radiation comprises a third radiation which is a portion of the processing beam reflected from the workpiece, which is reflected back into the beam path of the processing beam;
the analysis device comprises an astigmatic lens and a position-sensitive detector;
the position-sensitive detector and the astigmatic lens are configured such that the third radiation passes through the astigmatic lens onto the position-sensitive detector and the position-sensitive detector provides a position signal in response thereto.

10. The laser processing device according to claim 9, wherein the astigmatic lens is arranged between the position-sensitive detector and a polarizer, wherein the processing beam first passes through the polarizer and in the opposite direction, coming from the workpiece, the polarizer directs the third radiation onto the position-sensitive detector.

11. The laser processing device according to claim 1, wherein
the radiation comprises a fourth radiation which is generated by interaction of the processing beam with the workpiece; and
the analysis device is adapted to analyze the fourth radiation.

12. The laser processing device according to claim 1, further comprising a retardation plate and a polarizer which are arranged in a ray path of the laser radiation;
wherein the retardation plate is rotatably supported about an axis of rotation, wherein a rotation of the retardation plate about the axis of rotation causes a rotation of a direction of polarization of the processing beam and thereby a power of a portion of the processing beam decoupled by the polarizer is variable.

13. The laser processing device according to claim 1, further comprising an image sensor with which a light reflected from the workpiece is recordable to generate image data of a surface of the workpiece.

14. A laser device comprising
at least two laser processing devices for processing a workpiece with a processing beam formed by at least a portion of a provided laser radiation, each laser processing device comprising:
an analysis device for analyzing a radiation which is based on the laser radiation;
a control device configured to adjust at least one parameter of the processing beam based on the analysis of the radiation;
wherein for each laser processing device of the at least two laser processing devices, a parameter of its processing beam is adjustable independently of the processing beams of the other laser processing devices of the at least two laser processing devices.

15. A method of processing a workpiece with a processing beam formed by at least a portion of a provided laser radiation, the method comprising:
analyzing a radiation which is based on the laser radiation;
adjusting at least one parameter of the processing beam based on the analysis of the radiation.
